(19) United States
(12) Patent Application Publication
(10) Pub. No.: US 2009/0307069 A1
(43) Pub. Date: Dec. 10, 2009

(54) PROMOTIONAL COUPON SYSTEM WITH ANONYMOUS PLAYER TRACKING IN A GAMING ENVIRONMENT

(75) Inventor: Eric Meyerhofer, Pasadena, CA (US)

Correspondence Address: FITZPATRICK CELLA HARPER & SCINTO, 1290 Avenue of the Americas, NEW YORK, NY, 10104-3800, US

(73) Assignee: FutureLogic, Inc., Glendale, CA (US)

(21) Appl. No.: 12/162,780

(22) PCT Filed: Jan. 30, 2007
(86) PCT No.: PCT/US07/02663

§ 371 Date: Jan. 14, 2009

Related U.S. Application Data
(60) Provisional application No. 60/763,533, filed on Jan. 30, 2006.

(51) Int. Cl. G06Q 30/00; G06Q 50/00

(52) U.S. Cl. 705/14.12; 705/14.13; 705/14.25; 705/14.36

(57) ABSTRACT

Methods and apparatuses for a promotional coupon system which can provide promotions and promotional coupons to all patrons of a casino, specifically to patrons who do not want to provide personal information yet would enjoy receiving promotions. Casinos can track an anonymous player and offer incentives such as promotional coupons to the player to entice them to return to the casino. The system provides a means for the creation and issuance of promotional coupons as well as the tracking of the redemption of such coupons and the tracking of anonymous players, to provide real-time monitoring of a gaming printer's activities; for connecting to other existing systems in a casino, such as an accounting system or point-of-sale system. Additionally, such a system may use existing equipment such as a gaming printer to produce such coupons, however, only after the existing equipment produces a cash-out voucher.

### CROSS-REFERENCE TO RELATED APPLICATIONS

The present application claims the benefit us U.S. Provisional Application No. 60/763,533 filed Jan. 30, 2006, the contents of which are incorporated by reference as if stated in full herein.

### BACKGROUND OF THE INVENTION

This invention relates generally to printers and printer connected hardware used in cash-less slot machines and gaming, and more specifically to hardware and software operating within this equipment performing promotional ticket printing, promotional data basing and printer connected hardware based promotional ticket triggering.

The gaming machine manufacturing industry provides a variety of gaming machines for the amusement of gambling players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers provide cash-less enabled games to the market and there now exists a broad population of such games in the casino industry. Cash-less enabled games are so named because they can conduct their player's financial exchange with a mixture of traditional paper and coin currency and vouchers redeemable for cash or game credits.

Two pieces of equipment used for a cash-less enabled game are a printer to produce the vouchers, and a bill acceptor that supports automatic reading of the vouchers. In a cash-less enabled gaming system, when a player cashes out, the game is signaled and depending on the size of the pay out, it can either present coins in the traditional method of a slot machine, or it can cause the printers which are installed in such machines to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

Cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers which may be used to print coupons and promotions for the captive player audiences.

Currently, in typical casino operations, the games are networked to a main server which monitors various metrics of activity on the games for regulatory, accounting and promotional activities. The server related to promotions for player club cards is referred to as the Player Tracking Sever. Gaming machines share real-time play metrics with the Player Tracking Server in order to support frequent player incentives.

One problem that exists with the current situation is that not all players are part of the Player Tracking System, since the player may desire anonymity thereby not wanting to disclose personal information to a casino. Another problem that exists is that not all casinos use a Player Tracking System. Another problem that exists is that either due to a patron's desire for anonymity, a casino's lack of use of a Player Tracking System, or both, a casino risks losing a valuable or hot player to another casino.

Therefore, a need exists for a system which can provide promotions and promotional coupons to all patrons of a casino, specifically to patrons who do not want to provide personal information yet would enjoy receiving promotions. This system should also allow a casino to track an anonymous player and offer incentives such as promotional coupons to the player to entice them to return to the casino.

Further, it would be advantageous to provide a way to create and issue promotional coupons as well as track the redemption of such coupons; provide real-time monitoring of a gaming printer's activities; connect to other existing systems in a casino, such as an accounting system or point-of-sale system. Additionally, such a system should use existing equipment such as a gaming printer to produce such coupons.

The methods and apparatus of the present invention provide the foregoing and other advantages.

### DEFINITIONS

The following terms have the associated meanings as used herein:
“PCS”—Promotional Coupon System. This is the system which is responsible for creating and managing promotional coupons in the gaming environment.
“GVP”—Game Installed Voucher Printer. This is the printer attached to a slot machine, gaming machine, gaming table, or casino installed kiosk whose primary responsibility is the printing of cash-out vouchers.
“Gaming Machine”, “Game Machine”, “Game”—A slot machine, gaming machine, or game table in a casino.
“Cash-out Voucher System”—The system installed in a casino used to create cash-out voucher records and issue data packages to Gaming Machines which will cause it to print a cash-out voucher. A Cash-out Voucher System is a rudimentary part of the existing casino industry architecture for casinos supporting cashless gaming.
“Point of Redemption”—Any kiosk, point-of-sale, game, cashier's cage, or other means whereby a player can redeem a promotional coupon.
“Coupon Trigger Metrics”—Are defined below.
“Coupon Issuance Control Parameters”—Are defined below
“PTS”—Player Tracking System.
“PSP”—Player Session Packet as defined below

### SUMMARY OF THE INVENTION

In one aspect of the invention, a promotional coupon system includes a central data processing unit such as a network server (“PCS”), a plurality of gaming machines, each gaming machine including a Game Installed Voucher Printer (“GVP”), each GVP connected through a primary communication port to the controller of the gaming machine into which it is installed, each GVP further connected to a central data processing unit through an second auxiliary port, the GVP receiving signaling for cash-out vouchers through the primary communications port and signaling for promotional coupons through the second auxiliary port.

In another aspect of the invention, a GVP connected to a PCS receives signaling from the PCS to generate a promotional coupon or plurality of such, the promotional coupon including an authorization code, the authorization code which may be unique to each promotional coupon issued by the PCS regardless of the number of times the same promotional coupon was issued to various players.

In another aspect of the invention, a PCS includes a processor, memory, application code containing processes, storage, and a plurality of interfaces to external devices and systems including an interface to a plurality of printers. An exemplary device for the PCS would be a traditional network server. An exemplary system would be a Player Tracking System (PTS).

In another aspect of the invention, a PCS and components thereof issue a promotional coupon to a player, the player being unknown or anonymous to the PCS or any other system used in a casino, such as a PTS.

In another aspect of the invention, a PCS and components thereof issue a promotional coupon to a player, the player being identified to the PCS or any other system used in a casino, such as a PTS.

In another aspect of the invention, a PCS connected to one or a plurality of kiosks, games, cashier's cages, and point-of-sale systems, among others, (herein referred to as “Point of Redemption”) any or all of which may be connected to a network. The PCS issues a promotional coupon to a player and the Point of Redemption is used to redeem the promotional coupon.

In another aspect of the invention, a Point of Redemption requests from a PCS validation of a promotional coupon, the PCS signals the Point of Redemption as to the validity of a promotional coupon, the Point of Redemption processes the redemption of the coupon, if valid or returns the coupon to player if invalid, the Point of Redemption further signals the PCS of the redemption, the PCS updates data related to the promotional coupon, and the PCS may further process data related to an authorization code.

In another aspect of the invention, a PCS tracks the activities of an anonymous player without collecting the player's personal data such as name or address or without the player being part of a PTS by way of an authorization code, issued by the PCS for tracking an anonymous player.

In another aspect of the invention, a PCS is connected to a PTS, the PCS requests from the PTS an authorization code, the PTS issues a unique authorization code without further processing a patron in the PTS and the PCS processes the code for the tracking of an anonymous player.

In another aspect of the invention, a PCS is connected to a PTS. The PCS offers incentives to entice a patron to join the PTS, if the PTS is used in the casino.

In another aspect of the invention, a PCS and components thereof issues a series of promotional coupons to a player based on the activities of that player captured through the PCS's means of tracking the player. To do so, the PCS issues a unique identifier for each promotional coupon issued to the player, and the unique identifier may be sequentially numbered.

In another aspect of the invention, a PCS is connected to a gaming machine, the PCS receives signaling from the gaming machine such as a cash-in or cash-out signal, the PCS processes the signaling, with data from the signaling becoming a trigger which is used to track an anonymous player.

In another aspect of the invention, a PCS is connected to a GVP, the PCS receives signaling from the GVP such as a cash-out signal or cash-out amount. The PCS processes the signaling with data from the signaling becoming a trigger which is used to track an anonymous player

In another aspect of the invention, a PCS using application code, processes, a processor, memory, storage, and an interface to external devices and systems tracks the activities of a player through the redemption of one or a plurality of promotional coupons issued to that player whereby data used from the redemption of a coupon is associated with an authorization code for the tracking of an anonymous player.

In another aspect of the invention, a PCS using application code, processes, a processor, memory, storage, and an interface to external devices and systems tracks the activities of a player through the redemption of one or a plurality of promotional coupons issued to that player whereby a trigger may be set when the first of a plurality of promotional coupons is redeemed, the trigger initiating the tracking of an anonymous player, the tracking may be based on an authorization code, a unique identifier of a promotional coupon, or a combination thereof, among others, the trigger causing an association of a player and the player's activities with promotional coupon data whereby additional promotional coupons may be issued to an anonymous player.

In another aspect of the invention, data for the issuance of a promotional coupon is validated against data collected during the redemption of a promotional coupon, the validation may further include validating an authorization code with promotional coupon data.

In another aspect of the invention, a Point of Redemption is connected to a keypad whereby an authorization code is entered using the keypad to process redemption of a promotional coupon.

In another aspect of the invention, a Point of Redemption connected to a bill validator whereby the bill validator is used to scan a barcode on a promotional coupon to process redemption of a promotional coupon.

In another aspect of the invention, an authorization code may be in a human- or machine-readable format, such as a barcode, or a combination thereof.

In another aspect of the invention, an authorization code may be issued and printed on a promotional coupon or issued and printed separately.

In another aspect of the invention, an authorization code may be a unique code.

In another aspect of the invention, an authorization code may be a player identification number from a PTS.

In another aspect of the invention, promotional coupons may include coupons for merchandise, food, beverages, parking, lodging, special events such as a boxing or a tournament, personal events such as a birthday or an anniversary, entertainment, and a free play of a game or certain types of games.

In another aspect of the invention, the promotional coupons may offer a discount, a refund, a rebate, or a free product or service.

In another aspect of the invention, promotions may include those for a tangible or intangible product, a service, an event, and lodging. Promotions may be associated with one or a plurality of promotional campaigns.

In another aspect of the invention, promotional campaigns may include those for events such as a holiday, contest, drawing, tournament, and other special events such as boxing.

In another aspect of the invention, data and/or triggers related to promotional coupons, promotions, promotional campaigns, and authorization codes may be transmitted to, stored in, and/or used by a PCS, GVP, Point of Redemption, among others. The data may be stored partially resident in the GVP and partially supplied by the PCS.

In another aspect of the invention, a PCS connected to memory and storage houses a database or plurality of such containing data such as triggers, a unique identifier for each promotional coupon, the type of promotion offered, a unique identifier for each promotional campaign, the promotional coupons associated with each promotional campaign, available authorization codes, expired (or used) authorization codes, promotional coupon issuance date, and redemption data, among others.

In another aspect of the invention, the PCS transmits to one or a plurality of GVPs unsolicited data, the unsolicited data may include player game activity as a Player Session Packet (“PSP”), wherein the PSP may contain data that may indicate how much a player bet on a particular game, amount won or lost, amount of win, amount of money deposited into a game machine, if a player is cashing out, among others, the PSP may include trigger metrics and/or control parameters as disclosed below.

In another aspect of the invention, the PCS receives from one or a plurality of GVP, a PSP or plurality of such.

In another aspect of the invention, the PCS receives from one or a plurality of gaming machines or a component thereof, a PSP or plurality of such.

In another aspect of the invention, the PSP may include player identification information from a Player Tracking System.

In another aspect of the invention, the PCS includes a coupon trigger database which may contain various play metrics that may cause the PCS to request a GVP to produce a promotional coupon when satisfied, the metrics including the following among others and herein referred to as “Coupon Trigger Metrics”:
(a) anytime a cash-out voucher is printed;
(b) a cash-out voucher for greater than, equal to, or less than a specified amount of money is printed;
(c) the amount of money wagered over a particular time period;
(d) the amount of money won over a particular time period;
(e) the amount of money lost over a particular time period;
(f) the duration of play on the game;
(g) anytime a player adds money or credits to a game in an amount greater than, equal to, or less than a specified amount;
(h) the time when the game is is played or cashed-out;
(i) the day when a game is is played or cashed-out;
(j) the date when a game is is played or cashed-out;
(k) the average percentage of the maximum wagering on the game which the player's activity represents;
(l) a random percentage change that a coupon will be issued when a player cashes out;
(m) for participating frequent player club members, a player's birthday;
(n) for participating frequent player club members, the classification of the player is applied to modify any of the foregoing metrics.

In another aspect of the invention, a GVP receives from the PCS the Coupon Trigger Metrics, the GVP analyzes game activity passed to it by the PCS against the Coupon Trigger Metrics, and the GVP produces a promotional coupon when the metrics are satisfied.

In another aspect of the invention, a PCS includes a control parameters database which may select the type and quantity of promotional coupons to create and issue related to any of the Coupon Trigger Metrics, the control parameters operate separately or in combination with each coupon, the control parameters reside in and are utilized in procedures either on the PCS or a GVP or combination thereof, the control parameters including the following among others and herein referred to as “Coupon Issuance Control Parameters”:
(a) the total quantity of a coupon is issued before it is retired;
(b) the frequency of issuance of a coupon, one issued every time a specified number of trigger events occurs;
(c) the frequency of issuance of a coupon based on a random chance of one in every so many trigger events;
(d) an alternative coupon should a particular coupon fail to print for lack of satisfying all of its Coupon Trigger Metrics and/or its specified set of control parameters.

In another aspect of the invention, a GVP uses procedures, Coupon Trigger Metrics, and Coupon Issuance Control Parameters to produce a promotional coupon if metrics and parameters are satisfied.

In another aspect of the invention, a PCS uses promotional coupon data and procedures including sending promotional coupon information to one or more coupled GVPs, the information is static data or variable data. The static data may contain various fixed portions of the printed indicia of promotional coupons which a GVP may use in the future creation of a promotional coupon, the static data may include one or a plurality of Coupon Trigger Metrics, one or a plurality of Coupon Issuance Control Parameters, a unique promotional campaign identifier, an authorization code, among others, the static data stored in the memory coupled to a GVP. The variable data may contain portions of printed indicia of promotional coupons or a unique promotional campaign identifier, an authorization code, among others, the variable data matched by a GVP to any variable data stored in the GVP's memory, the GVP combining portions of static and variable data to print a promotional coupon.

In another aspect of the invention, a GVP transmits an authorization code to a PCS, wherein the authorization code may be verified within the PCS, for example, to track promotional coupon redemption or retire a promotional coupon from issuance.

In another aspect of the invention, a GVP utilizes arbitration in the printing of vouchers and promotional coupons, the GVP coupled to a PCS and a cash-out voucher system, both systems coupled to each other, wherein the GVP uses procedures included in its memory and data or signaling from both or either system generates vouchers without delay and prior to any coupon is generated.

In another aspect of the invention, the GVP receives player activity data of the gaming machine in which it is installed from the PCS, the GVP processes the data according to procedures contained in its memory, the GVP determines if a promotional award has been triggered by the player activity and the type of the award, the GVP signals the PCS as to various metrics of the triggered promotional award, the PCS processes the metrics of the promotional award, the PCS operates a procedure to create a validation identifier for the promotional coupon, the PCS signals the GVP with data including the validation identifier and authorization to print the promotional coupon, the GVP prints the coupon, and the GVP signals the PCS as to the completion or failure of its print job.

In another aspect of the invention, the PCS having received the signaling from the GVP as to the completion or failure of a promotional award print job, creates a record in its memory as to the issuance of the promotional coupon.

In another aspect of the invention, the PCS contains a record of promotional coupons issued by the GVPs in its memory, the PCS is connected to a Point of Redemption, the PCS receives signaling from the Point of Redemption when a coupon is redeemed as to the validation sequence of the coupon, the PCS checks the validity of the coupon against its records, the PCS signals the Point of Redemption as to the validity of the coupon, and the PCS records the redemption of the coupon in its memory.

In another aspect of the invention, the PCS stores data related to outstanding and redeemed promotional coupons from its database in memory.

In another aspect of the invention, the GVP receives signaling from the PCS on its secondary auxiliary port to print a promotional coupon, the GVP holds the coupon data in its memory, the GVP receives signaling from the gaming machine to which it is coupled on its primary port to print a cash-out voucher, the GVP prints the cash-out voucher, and when successfully completed, prints the coupon from the coupon data held in its memory.

### BRIEF DESCRIPTION OF THE DRAWINGS

These and other features, aspects, and advantages of the present invention will become better understood with regard to the following description and accompanying drawings where:

FIG. 1 is an illustration of the PCS, a plurality of Gaming Machines, a plurality of GVPs, and the connection thereof in accordance with an exemplary embodiment of the present invention.

FIG. 2 is an illustration of the issuance and redemption of a promotional coupon using the PCS, a plurality of Point of Redemption, and an authorization code in accordance with an exemplary embodiment of the present invention.

FIG. 3 is an illustration of the tracking of an anonymous player in accordance with an exemplary embodiment of the present invention.

FIG. 4 is an illustration of the components of the PCS in accordance with an exemplary embodiment of the present invention.

FIG. 5 is a diagram of a promotional coupon issuance process in accordance with an exemplary embodiment of the present invention.

FIG. 6 is a diagram of a promotional coupon redemption process in accordance with an exemplary embodiment of the present invention.

FIG. 7 is a diagram of a PTS acceptance process in accordance with an exemplary embodiment of the present invention.

FIG. 8 is an illustration of arbitration process of a GVP in producing gaming vouchers and promotional coupons in accordance with an exemplary embodiment of the present invention.

FIG. 9 is a tabular view of the databases and associations thereof for the tracking of an anonymous player in accordance with an exemplary embodiment of the present invention.

FIG. 10 is a tabular view of the databases and associations thereof for the redemption of promotional coupons in accordance with an exemplary embodiment of the present invention.

FIG. 11 is an architecture diagram of a GVP in accordance with an exemplary embodiment of the present invention.

FIG. 12 is an architecture diagram of a Point of Redemption in accordance with an exemplary embodiment of the present invention.

### DETAILED DESCRIPTION

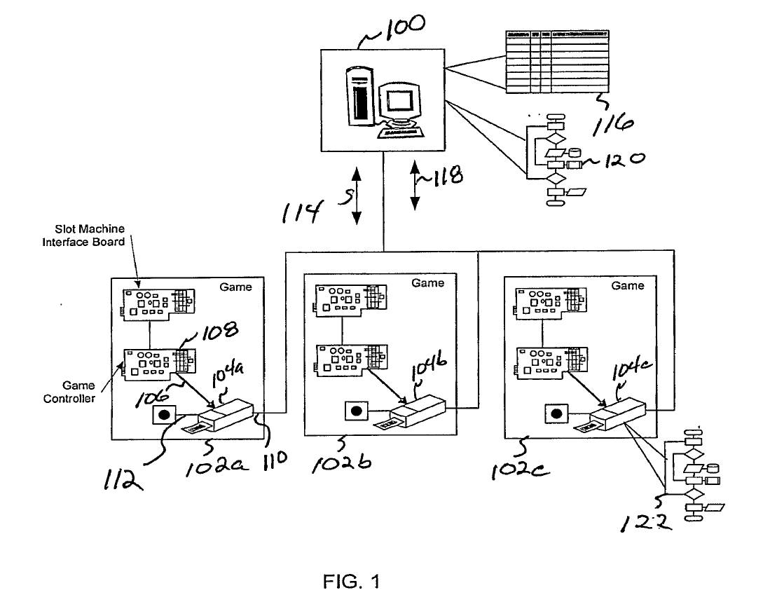

FIG. 1 is an illustration of an exemplary connection of a PCS 100, a plurality of gaming machines, such as gaming machines 102a, 102b and 102c, and a plurality of GVPs, such as GVPs 104a, 104b and 104c, in accordance with an exemplary embodiment of the present invention. The PCS as shown in the diagram, is a server who's responsibility is to direct the promotional activity of a GVP installed in a gaming machine. In an exemplary implementation, each GVP has three ports or channels; a primary port 106 connects the GVP to a controller 108 of the gaming machine in which the GVP is installed for cash-out vouchers, a second auxiliary port 110 for connection to the PCS for promotional couponing, and a third auxiliary port 112 for the real-time monitoring of printer activities.

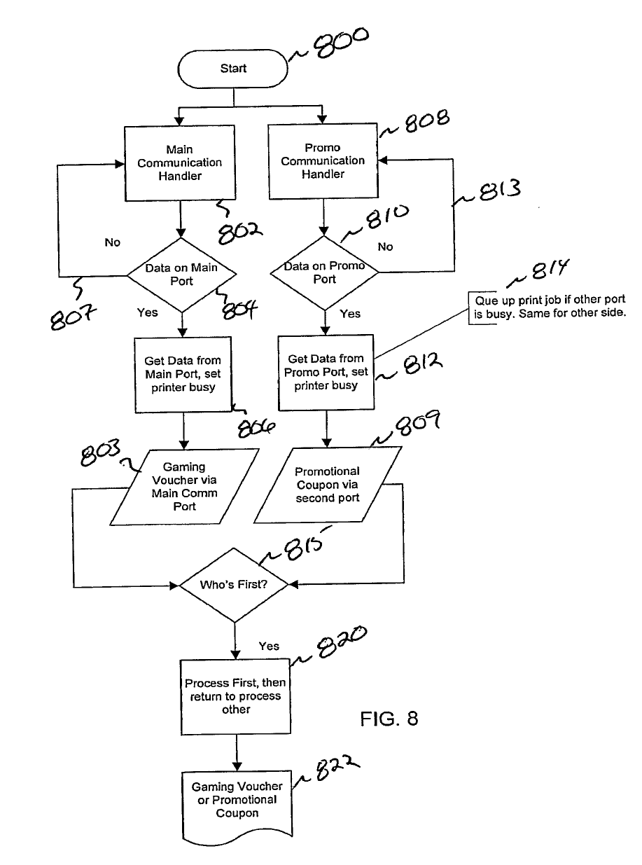

Each GVP has a unique address by which the GVP can specifically be selected. An Ethernet network would be an exemplary setup, where the GVP's address is an IP address on the network. One of the fundamental responsibilities of the GVP, considering that it has in essence two masters, one is the gaming machine controller and the other is the PCS, is arbitration of traffic on the two or more ports or channels as later discussed in FIG. 8. The complexity of this is increased since the two masters are operating asynchronously from each other.

Additionally, the PCS may function as a player tracking system, connected to and distributed over a plurality of gaming machines and a plurality of GVPs connected in relation to each other. In this embodiment, the PCS receives information about player activity on a game to which it is connected. As used herein, data packets containing player gaming machine activity are referred to as Player Session Packets (PSPs) 114, and an example of the data would indicate that a player had bet so much on a particular game, had won or lost the bet, the amount of a win, the amount of money deposited in the machine, if a player was cashing out, and so on. The PCS, as a player tracking system, would determine by using procedures 120 and processing the packet which gaming machine the PSP originated from, look up from an internal database 116 which GVP IP address was related to that gaming machine, and forward the PSP to that IP address, essentially sending it to the GVP. The GVP using procedures 122 then processes information from the PSP to determine if a coupon trigger condition is met. If a condition was met, the GVP informs the PCS of an award, requests a validation identifier or authorization 118 for the coupon, and obtains permission from the PCS to print the coupon. If approved, additional handshaking is conducted to ensure that the coupon was successfully produced, and the PCS then logs the validation number or authorization and the award type into the PCS's internal memory or database 122 for later reconciliation.

In another embodiment of the invention, the PCS performs the analysis of the PSPs against a set of trigger conditions, and when a condition is met, the PCS signals the GVP with a coupon and a validation sequence for the coupon. Upon receipt of data from the PCS, the GVP produces the promotional coupon. In this embodiment, handshaking applicable to the success/failure of the coupon print job is also conducted.

Another variation of this model uses a multiplexer port or channel instead of two dedicated ports. In this variation, signaling related to promotional coupons and real-time printer activity monitoring is processed using a multiplexer port on the GVP.

The 3rd auxiliary port 112 may be used for real-time monitoring. An example of the real-time monitoring is a printer activities requested from the PCS and reported by a GVP. The data from the printer activities request may include any promotional coupon activity performed by the GVP including any Coupon Trigger Metrics, any Coupon Issuance Control Parameter, number of coupons printed, number of times a template was used to produce a coupon, among others.

Another example of the printer activities requested from the PCS and reported by a GVP may include any voucher activity performed by the GVP including a cash-out request by a player, number of vouchers printed, and number of times a template was used to produce a voucher, among others.

Another example of the printer activities requested from the PCS and reported by a GVP may include other printer activity such as any printing error, if printer is busy, if paper out, low, or jammed, temperature or voltage condition, data error, memory error, printer online or offline, printer in sleep mode, printer door open, any power reset, historical data on the print head, print job failed, or print job completed, among others,

Additionally, the real-time printer activities may include a date/time stamp, GVP unique ID, among others.

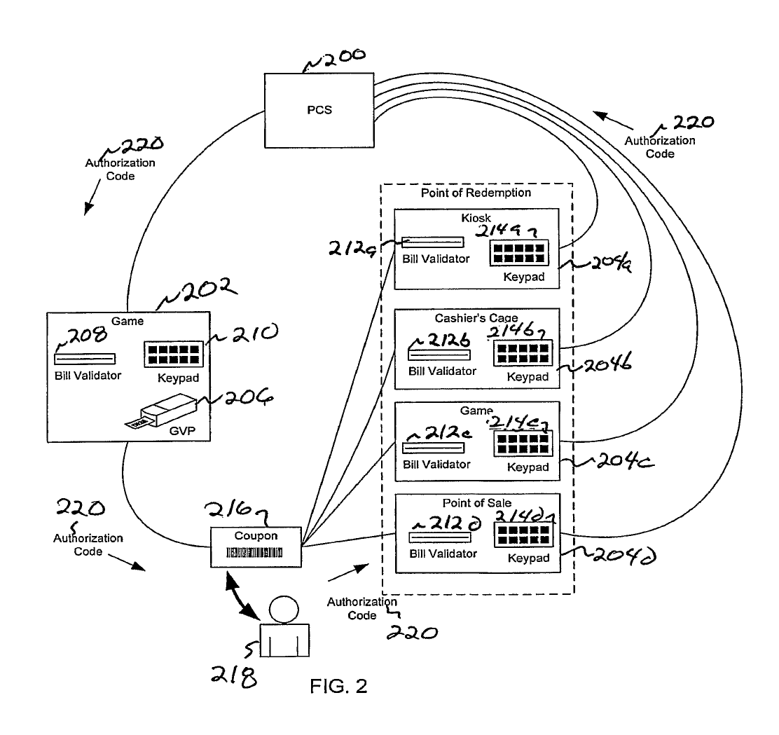

FIG. 2 is an illustration of the issuance and redemption of a promotional coupon using the PCS, a plurality of Points of Redemption, and an authorization code in accordance with an exemplary embodiment of the present invention. The exemplary embodiment includes a PCS 200 connected to a plurality of gaming machines although FIG. 2 illustrates only one gaming machine 202 although it is to be understood that a typical system includes a plurality of gaming machines. Additionally, the PCS is connected to a plurality of Points of Redemption such as a kiosk 204a, cashier's cage 204b, gaming machine 204c, or point of sale system 204d. Each gaming machine is connected to a GVP 206, bill validator 208, and keypad 210, among other devices not shown. Each Point of Redemption may be connected to a keypad, such as keypads 212a to 212d and a bill validator, such as bill validators 214a to 214d, among other devices not shown.

In an exemplary embodiment, the PCS signals a GVP in a gaming machine to issue a promotional coupon 216 to a player 218. Additionally, the PCS may also provide an authorization code 220 for the promotional coupon. For the purposes of redemption, a promotional coupon may be redeemed in one of two methods. In one method, the promotional coupon is inserted into a bill validator of a Point of Redemption upon which information from the promotional coupon is validated by the PCS.

A second method which also encompasses the first uses an authorization code for the tracking of an anonymous player. During redemption, a player enters an authorization code into a keypad of a Point of Redemption. The authorization code is transmitted to the PCS. The authorization code may cause a trigger to occur for anonymous player tracking.

An example tracking process may be valid authorization code+ticket number=internal tracking number. For example, when a player redeems the first promotional coupon, say 543, using an authorization code, say 396, and all parameters for the redemption of promotional coupon 543 are met, a trigger using one or more Coupon Issuance Control Parameters, Coupon Trigger Metrics, or combination thereof sets a tracking process in motion whereby the PCS issues an internal tracking number of 543-396a to the first occurrence of redemption of a promotional coupon, 543-396b to the second occurrence, and so on. In this embodiment, the PCS may use an internal tracking number or series of such to identify an anonymous player and associated activity.

In another embodiment of the invention, a GVP connected to a PCS receives signaling from the PCS to generate a promotional coupon or plurality of such with the promotional coupon including an authorization code. The authorization code is unique to each promotional coupon issued by the PCS regardless of the number of times the same promotional coupon was issued to various players.

In another embodiment of the invention, a PCS and components thereof issue a promotional coupon to a player, the player being identified to the PCS or any other system used in a casino, such as a PTS.

In another embodiment of the invention, the PCS transmits to one or a plurality of GVPs unsolicited data, the unsolicited data may include player game activity as a Player Session Packet (“PSP”), wherein the PSP may contain data that may indicate how much a player bet on a particular game, amount won or lost, amount of win, amount of money deposited into a game machine, if a player is cashing out, among others, the PSP may include trigger metrics and/or control parameters as disclosed below.

In another embodiment of the invention, the PCS receives from one or a plurality of GVP, a PSP or plurality of such.

In another embodiment of the invention, the PCS receives from one or a plurality of gaming machines or a component thereof, a PSP or plurality of such.

In another embodiment of the invention, the PSP may include player identification information from a Player Tracking System.

In another embodiment of the invention, the PCS includes a coupon trigger database which may contain various play metrics that may cause the PCS to request a GVP to produce a promotional coupon when satisfied, the metrics including the following among others and herein referred to as “Coupon Trigger Metrics”:
(o) anytime a cash-out voucher is printed;
(p) a cash-out voucher for greater than, equal to, or less than a specified amount of money is printed;
(q) the amount of money wagered over a particular time period;
(r) the amount of money won over a particular time period;
(s) the amount of money lost over a particular time period;
(t) the duration of play on the game;
(u) anytime a player adds money or credits to a game in an amount greater than, equal to, or less than a specified amount;
(v) the time when the game is is played or cashed-out;
(w) the day when a game is is played or cashed-out;
(x) the date when a game is is played or cashed-out;
(y) the average percentage of the maximum wagering on the game which the player's activity represents;
(z) a random percentage change that a coupon will be issued when a player cashes out;
(aa) for participating frequent player club members, a player's birthday;
(bb) for participating frequent player club members, the classification of the player is applied to modify any of the foregoing metrics.

In another embodiment of the invention, a GVP receives from the PCS the Coupon Trigger Metrics, the GVP analyzes game activity passed to it by the PCS against the Coupon Trigger Metrics, and the GVP produces a promotional coupon when the metrics are satisfied.

In another embodiment of the invention, a PCS includes a control parameters database which may select the type and quantity of promotional coupons to create and issue related to any of the Coupon Trigger Metrics, the control parameters operate separately or in combination with each coupon, the control parameters reside in and are utilized in procedures either on the PCS or a GVP or combination thereof, the control parameters including the following among others and herein referred to as “Coupon Issuance Control Parameters”:
(e) the total quantity of a coupon is issued before it is retired;
(f) the frequency of issuance of a coupon, one issued every time a specified number of trigger events occurs;
(g) the frequency of issuance of a coupon based on a random chance of one in every so many trigger events;
(h) an alternative coupon should a particular coupon fail to print for lack of satisfying all of its Coupon Trigger Metrics and/or its specified set of control parameters.

In another embodiment of the invention, a GVP uses procedures, Coupon Trigger Metrics, and Coupon Issuance Control Parameters to produce a promotional coupon if metrics and parameters are satisfied.

In another embodiment of the invention, a PCS uses promotional coupon data and procedures including sending promotional coupon information to one or more coupled GVPs, the information is static data or variable data. The static data may contain various fixed portions of the printed indicia of promotional coupons which a GVP may use in the future creation of a promotional coupon, the static data may include one or a plurality of Coupon Trigger Metrics, one or a plurality of Coupon Issuance Control Parameters, a unique promotional campaign identifier, an authorization code, among others, the static data stored in the memory coupled to a GVP. The variable data may contain portions of printed indicia of promotional coupons or a unique promotional campaign identifier, an authorization code, among others, the variable data matched by a GVP to any variable data stored in the GVP's memory, the GVP combining portions of static and variable data to print a promotional coupon.

In another embodiment of the invention, a GVP transmits an authorization code to a PCS, wherein the authorization code may be verified within the PCS, for example, to track promotional coupon redemption or retire a promotional coupon from issuance.

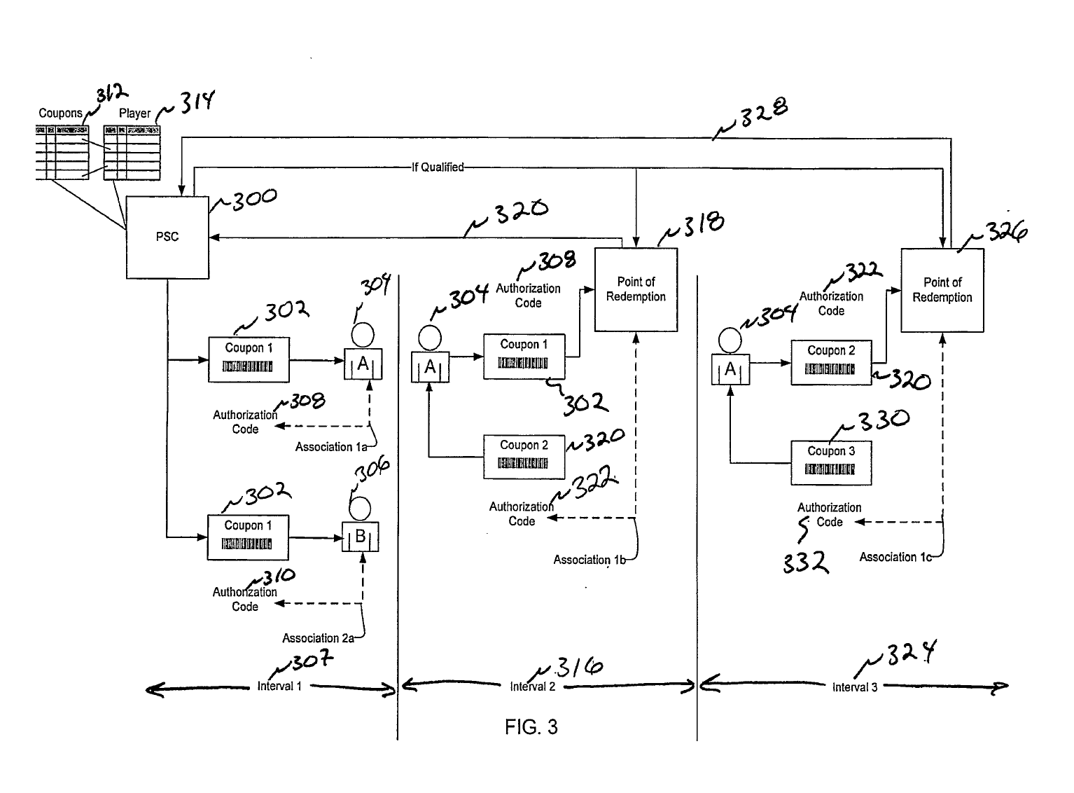

FIG. 3 is an illustration of the tracking of an anonymous player in accordance with an exemplary embodiment of the present invention. As shown, a PCS 300 and components thereof (all of which may not be shown) may issue the same promotional coupon (e.g., coupon 1 302) to multiple players (e.g., player A, 304 and Player B, 306) at an interval 1 307 defined by a casino, such as within a day. Each player also receives a unique authorization code, namely authorization codes 308 and 319, thereby creating or beginning an association between an anonymous player and an authorization code, such as association 1a and association 2a. Each association is ultimately logged in the PCS by linking coupon data such as a coupon I.D. stored in a coupon data store or database 312 with the player data such as an authorization code stored in a player data store or database 314. Additionally, the association may include data from a PSP or plurality of PSPs.

When player A 304 returns to a casino at interval 2 316 to redeem coupon 1 302 in a Point of Redemption 318, the Point of Redemption signals (320) the PCS requesting. validation of the redemption of coupon 1 302. Parameters which must be met for the validation may include parameters set for the interval such as a date, the authorization code 308 as well as any promotional coupon data. Additionally, if player A 304 qualifies to receive another promotional coupon based on Coupon Trigger Metrics and/or Coupon Issuance Control Parameters set in the PCS, coupon 2 320 is issued to player A. Coupon 2 320 also has an associated authorization code 322 which may or may not be the same authorization code 308 issued with coupon 1 302. The issuance of coupon 2 320 and associated authorization code 322 become a second association (identified as association 1b) for player A 304 which a casino can use for anonymous player tracking.

Continuing with FIG. 3, when player A 304 returns to a casino at interval 3 324 to redeem coupon 2 320 using authorization code 322 in a Point of Redemption 326, the Point of Redemption 326 signals (328) the PCS requesting validation of the redemption. Parameters which must be met for the validation include those described in the previous paragraph. Additionally, if player A 304 qualifies to receive another promotional coupon based on Coupon Trigger Metrics and/or Coupon Issuance Control Parameters set in the PCS, coupon 3 330 is issued to player A. Coupon 3 330 also has an associated authorization code 332 which may or may not be the same authorization codes 322 or 308 issued with previously issued coupons. The issuance of coupon 3 330 and associated authorization code 332 become the third association (identified as Association 1c) for player A 304 which a casino can use for anonymous player tracking.

Additionally, a trigger based on one or a plurality of associations is set in the PCS which identifies an anonymous player as a returning player. The PCS using memory, storage, application code, and processes may use the trigger and data derived from the trigger to begin tracking an anonymous player. For example, a trigger can be set in the PCS on Association 1a. When coupon 1 is redeemed, the trigger may cause a new record to be created in the PCS which logs the authorization code, date the coupon was redeemed, the time of redemption, among other information. Subsequently, data pulled from the redemption of coupon 2 and coupon 3 as well as Association 1b and Association 1c also may be logged in the database of the PCS.

Now returning to player B 306 and the authorization code 310 given to player B 306 when issued coupon 1 302 at interval 1 307. In one embodiment, the authorization code 310 may be retired or reused since player B 306 did not return to the casino in interval 2 316. Additionally, Association 2a also may be retired or reused at a later date or time once the PCS deems Association 2a has expired. The PCS may log this information a database.

In another embodiment of the invention, a Point of Redemption requests from a PCS validation of a promotional coupon, the PCS signals the Point of Redemption as to the validity of a promotional coupon. In response, the Point of Redemption processes the redemption of the coupon, if valid or returns the coupon to player if invalid, the Point of Redemption further signals the PCS of the redemption, the PCS updates data related to the promotional coupon, and the PCS may further process data related to an authorization code.

In another embodiment of the invention, a PCS tracks the activities of an anonymous player without collecting the player's personal data such as name or address or without the player being part of a PTS by way of an authorization code, issued by the PCS for tracking an anonymous player.

In another embodiment of the invention, a PCS is connected to a PTS, the PCS requests from the PTS an authorization code, the PTS issues a unique authorization code without further processing a patron in the PTS and the PCS processes the code for the tracking of an anonymous player.

In another embodiment of the invention, a PCS and components thereof issues a series of promotional coupons to a player based on the activities of that player captured through the PCS's means of tracking the player. To do so, the PCS issues a unique identifier for each promotional coupon issued to the player, and the unique identifier may be sequentially numbered.

In another embodiment of the invention, a PCS is connected to a gaming machine or GVP, the PCS receives signaling from the gaming machine or GVP such as a cash-in or cash-out signal, the PCS processes the signaling, with data from the signaling becoming a trigger which is used to track an anonymous player.

In another embodiment of the invention, a PCS tracks the activities of a player through the redemption of one or a plurality of promotional coupons issued to that player whereby data used from the redemption of a coupon is associated with an authorization code for the tracking of an anonymous player.

In another embodiment of the invention, a PCS using application code, processes, a processor, memory, storage, and an interface to external devices and systems tracks the activities of a player through the redemption of one or a plurality of promotional coupons issued to that player whereby a trigger may be set when the first of a plurality of promotional coupons is redeemed, the trigger initiating the tracking of an anonymous player, the tracking may be based on an authorization code, a unique identifier of a promotional coupon, or a combination thereof, among others, the trigger causing an association of a player and the player's activities with promotional coupon data whereby additional promotional coupons may be issued to an anonymous player.

In another embodiment of the invention, data for the issuance of a promotional coupon is validated against data collected during the redemption of a promotional coupon, the validation may further include validating an authorization code with promotional coupon data.

In another embodiment of the invention, a Point of Redemption is connected to a keypad whereby an authorization code is entered using the keypad to process redemption of a promotional coupon.

In another embodiment of the invention, a Point of Redemption connected to a bill validator whereby the bill validator is used to scan a barcode on a promotional coupon to process redemption of a promotional coupon.

In another embodiment of the invention, an authorization code may be in a human- or machine-readable format, such as a barcode, or a combination thereof.

In another embodiment of the invention, an authorization code may be issued and printed on a promotional coupon or issued and printed separately.

In another embodiment of the invention, an authorization code may be a unique code.

In another embodiment of the invention, an authorization code may be a player identification number from a PTS.

In another embodiment of the invention, promotional coupons may include coupons for merchandise, food, beverages, parking, lodging, special events such as a boxing or a tournament, personal events such as a birthday or an anniversary, entertainment, and a free play of a game or certain types of games.

In another embodiment of the invention, the promotional coupons may offer a discount, a refund, a rebate, or a free product or service.

In another embodiment of the invention, promotions may include those for a tangible or intangible product, a service, an event, and lodging. Promotions may be associated with one or a plurality of promotional campaigns.

In another embodiment of the invention, promotional campaigns may include those for events such as a holiday, contest, drawing, tournament, and other special events such as boxing.

In another embodiment of the invention, data and/or triggers related to promotional coupons, promotions, promotional campaigns, and authorization codes may be transmitted to, stored in, and/or used by a PCS, GVP, Point of Redemption, among others. The data may be stored partially resident in the GVP and partially supplied by the PCS.

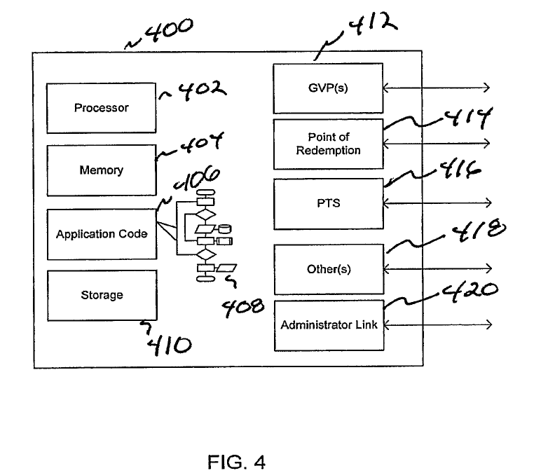

FIG. 4 is an illustration of the components of the PCS in accordance with an exemplary embodiment of the present invention. A component or plurality of components shown in FIG. 4 could be optional.

As shown in FIG. 4, a PCS 400 includes a processor 402, memory 404, application code 406 containing processes 408, storage 410, and a plurality of interfaces to external devices and systems including an interface 412 to a plurality of GVPs. An exemplary device for the PCS would be a traditional network server. Examples of interfaces to external systems include a Point of Redemption interface 414, a PTS interface 416, an interface to other devices or systems 418, and an Administrator Link 420. The processor executing the application code:
(a) creates and maintains data for promotional coupons, promotions, promotional campaigns, and authorization codes, among others, the data may further include data such as triggers, a unique identifier for each promotional coupon, the type of promotion offered, a unique identifier for each promotional campaign, the promotional coupons associated with each promotional campaign, available authorization codes, expired (or used) authorization codes, promotional coupon issuance date, and redemption data, among others.
(b) processes data to track an anonymous player, the data may include data received from a gaming machine, GVP, Point of Redemption, PTS, or Others such as a Slot Accounting System or Point of Sale.
(c) processes data to track an anonymous player, the data may include identifying a series of promotional coupons issued to an anonymous player, associating an anonymous player with a promotional coupon or plurality of such using an authorization code, among others.
(d) processes triggers used to track an anonymous player, the triggers may include a cash-out signal received from a gaming machine or a cash-in signal received from a gaming machine.
(e) processes data related to the creation of promotional coupons, promotions, and promotional campaigns, the data including triggers.
(f) processes data related to the issuance of promotional coupons, the data including triggers.
(g) processes data related to the redemption of promotional coupons, the data including triggers.
(h) processes data related to an association of one or a plurality of promotional coupons issued and an authorization code, the data including triggers.
(i) processes data related to an association of one or a plurality of authorization codes and an anonymous player, the data including triggers.
(j) requests data exchange through the PCS's interface to a GVP or plurality of such for the issuance of a promotional coupon or plurality of such, the data may be stored partially resident in a GVP and partially supplied by the PCS.
(k) requests data exchange though the PCS's interface to a Point of Redemption to monitor and track the redemption of a promotional coupon or plurality of such.
(l) requests data exchange though the PCS's interface to a Point of Redemption to validate the redemption of a promotional coupon or plurality of such, whereby data may be verified against data originally used to create a promotional coupon, promotion, promotional campaign, a plurality of any, or a combination of any.
(m) requests data exchange though the PCS's interface to a Point of Redemption to process data related to an authorization code and anonymous player tracking.
(n) requests data exchange through the PCS's interface with a PTS to process data related to an identified player, request an authorization code, or process data related to an anonymous player joining a PTS
(o) requests data exchange through the PCS's interface to other systems such as a Slot Accounting System or Point of Sale System to monitor and track the issuance and redemption of a promotional coupon or plurality of such.
(p) transfers statistical data and activity logs and records to the PCS administrator.
(q) accepts programming through its interface to an Administrator Link as to the processes, metrics, and triggers utilized for the creation of a promotional coupon, including promotion coupon templates or plurality of such, promotions, and promotional campaigns, among others.
(r) accepts programming through its interface to an Administrator Link as to the processes; metrics, and triggers utilized in anonymous player tracking, including authorization codes and related associations as previous disclosed.

The interfaces including the protocols, messaging logic, hardware, and buffering necessary to exchange data with the promotional couponing system's processor and application, and a:
(a) PTS
(b) POS
(c) Slot Accounting Server
(d) Gateway Server(s)
(e) Printer(s)
(f) Other systems or devices
(g) Administrator Link

A number of the interfaces for the system may exist on the same physical hardware connection, the attached devices being individually or group-addressable nodes on that connection.

Although the PCS has been described in terms of a computing system having a processor, computer-readable media, such as a memory, and instructions, such as a computer-executable program, executed by the processor, it is to be understood that the foregoing has been presented by way of example and not of limitation. It is to be understood that a PCS may also be implemented using software or the like, hardwired circuitry or the like, programmable components or the like, or any combination thereof.

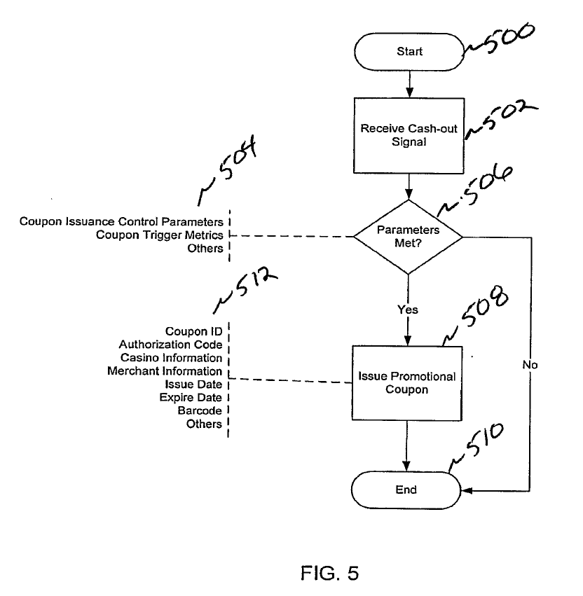

FIG. 5 is a diagram of a promotional coupon issuance process in accordance with an exemplary embodiment of the present invention. As illustrated, the process begins (500) with a PCS receiving (502) a cash-out signal. The cash-out signal may be received from a gaming machine or a GVP in a gaming machine. If the parameters 504 for the issuance of a promotional coupon are met (506), a PCS signals a GVP in a gaming machine to issue (508) a promotional coupon. Otherwise, the process ends (510).

The parameters may include Coupon Issuance Control Parameters, Coupon Trigger Metrics, and Others related to a promotion, promotional campaign, or promotional coupon, among others not shown.

The promotional coupon may include data 512 such as a Coupon ID, an Authorization Code, Casino Information, Merchant Information, Issue Date, Expire Date, and a Barcode, and Others not shown.

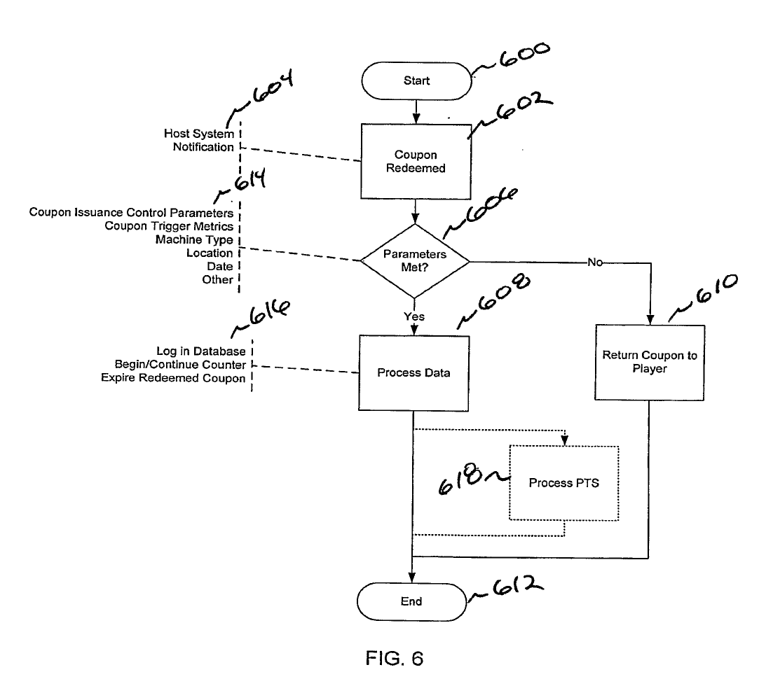

FIG. 6 is a diagram of a promotional coupon redemption process in accordance with an exemplary embodiment of the present invention. As illustrated, the process begins (600) with a promotional coupon begin redeemed (602) whereby a host system such as a PCS receives notification 604 of such. If the information is validated and parameters for the redemption of a promotional coupon are met (606), a PCS processes (608) data from the redemption. Otherwise, the coupon is returned (610) to the player and the process ends (612).

The parameters 614 may include Coupon Issuance Control Parameters, Coupon Trigger Metrics, Machine Type, Location, Date, and Other related to a promotion, promotional campaign, or promotional coupon, among others not shown.

The data 616 processed from a redemption may include a record Log in the Database, Begin or Continue a Counter or trigger, and Expire the Redeemed Coupon, among others not shown.

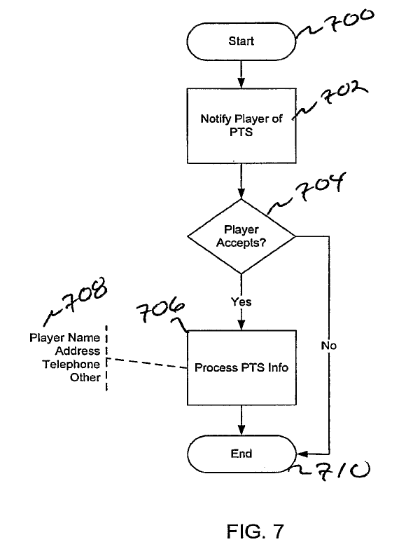

Optionally, the process may include processing 618 PTS data as disclosed in FIG. 7 whereby a player may receive an incentive to join a PTS, if a PTS exists in the casino.

In another aspect of the invention, the GVP receives player activity data of the gaming machine in which it is installed from the PCS, the GVP processes the data according to procedures (disclosed below) contained in its memory, the GVP determines if a promotional award has been triggered by the player activity and the type of the award, the GVP signaling the PCS as to various metrics of the triggered promotional award, the PCS processes the metrics of the promotional award, the PCS operates a procedure to create a validation identifier for the promotional coupon, the PCS signals the GVP with data including the validation identifier and authorization to print the promotional coupon, the GVP prints the coupon, and the GVP signals the PCS as to the completion or failure of its print job.

In another aspect of the invention, the PCS having received the signaling from the GVP as to the completion or failure of a promotional award print job (disclosed above), and the PCS creating a record in its memory as to the issuance of the promotional coupon.

In another embodiment of the invention, the PCS contains a record of promotional coupons issued by the GVPs in its memory, the PCS being connected to a Point of Redemption, the PCS receiving signaling from the Point of Redemption when a coupon is redeemed as to the validation sequence of the coupon, the PCS checking the validity of the coupon against its records, the PCS signaling the Point of Redemption as to the validity of the coupon, and the PCS recording the redemption of the coupon in its memory.

In another embodiment of the invention, the PCS stores data related to outstanding and redeemed promotional coupons from its database in memory.

In another embodiment of the invention, the GVP receiving signaling from the PCS on its secondary auxiliary port to print a promotional coupon, the GVP holding the coupon data in its memory, the GVP receiving signaling from the gaming machine to which it is coupled on its primary port to print a cash-out voucher, the GVP printing the cash-out voucher, and when successfully completed, printing the coupon from the coupon data held in its memory.

FIG. 7 is a diagram of a PTS acceptance process in accordance with an exemplary embodiment of the present invention. This process is optional if a PTS exists in a casino. As illustrated, the process begins (700) with a PCS or components thereof including triggers set notifying (702) a player if they want to join the PTS. If the player accepts (704), the process continues with processing (706) the PTS information 708 such as Player Name, Address, Telephone, and Other information not shown. If the player does not accept, the process ends 710.

FIG. 8 is an illustration of arbitration processing of a GVP in producing gaming vouchers and promotional coupons in accordance with an exemplary embodiment of the present invention. As illustrated, the process for gaming vouchers begins (800) with the main communication handler 802. If data, such as a gaming voucher 803, exists (804) on a main port of the GVP, the system gets (806) the data from the main port and sets the printer to busy. If data does not exist on the main port, the process returns (807) to the main communication handler.

The process for promotional coupons begins with the promo communication handler 808. If data, such as a promotional coupon 809, exists (810) on a second auxiliary or promo port of the GVP, the system gets (812) the data from the promo port and sets the printer to busy. If data does not exist on the promo port, the process returns (813) to the promo communication handler.

If the printer is busy using any port, the data from the other port is queued (814).

The process continues with the system identifying (815) which data, gaming voucher data 803 or promotional coupon data 809, was received first. After identifying the data received first, the system processes the first data to generate a gaming voucher or promotional coupon, then returns to process the second data to generate a gaming voucher or promotional coupon.

An example of one arbitration scheme would be the GVP always giving priority to a cash-out voucher print job which comes from the gaming machine (on the primary port), and then queuing a coupon print job from the PCS (on the second auxiliary port) behind the voucher. Another example of an arbitration scheme would be the GVP receiving a coupon print job on its second auxiliary port, and then holding the coupon for a period of time awaiting arrival of a cash-out voucher on the primary port. If the cash-out voucher didn't arrive within a reasonable amount of time, the coupon could either be printed or canceled by the GVP. In addition to coupon print data, the GVP would receive certain static promotional campaign data on its second auxiliary port. The static data could include graphic icons which are necessary to print on the various coupons, portions of the coupons which would never change with an award, and optionally, a set of trigger conditions which would cause the GVP to trigger a coupon.

Once a determination is made on which data, voucher or coupon, to print first, the GVP prints (820) the selected coupon or voucher 822 and then prints the other coupon or voucher.

In another embodiment of the invention, a GVP utilizes arbitration in the printing of vouchers and promotional coupons, the GVP coupled to a PCS and a cash-out voucher system, both system's coupled to each other, wherein the GVP uses procedures included in its memory and data or signaling from both or either system generates vouchers without delay and prior to any coupon is generated.

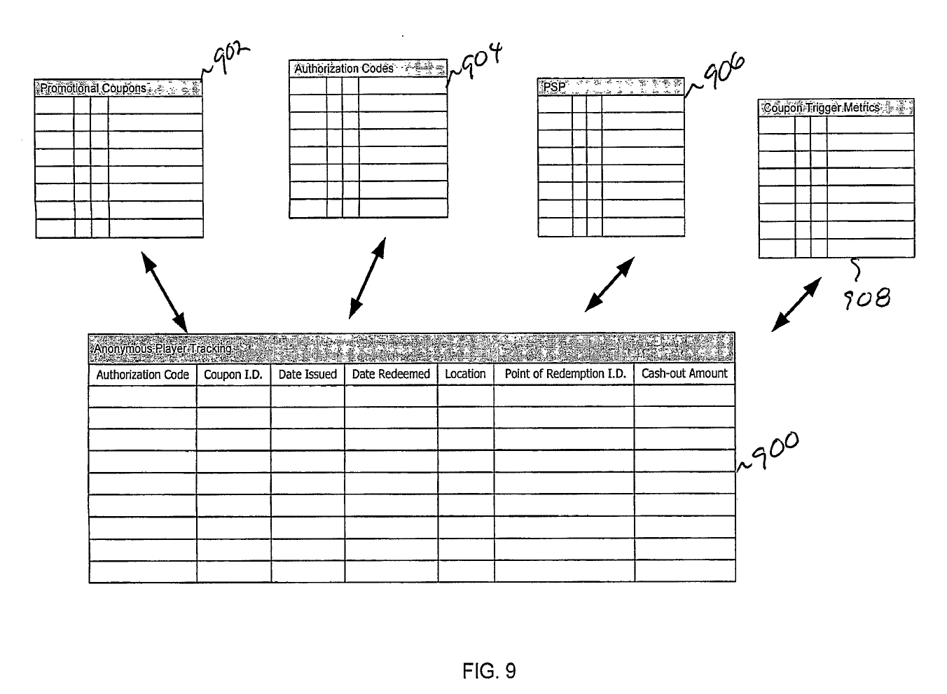

FIG. 9 is a tabular view of the databases and associations thereof for the tracking of an anonymous player in accordance with an exemplary embodiment of the present invention.

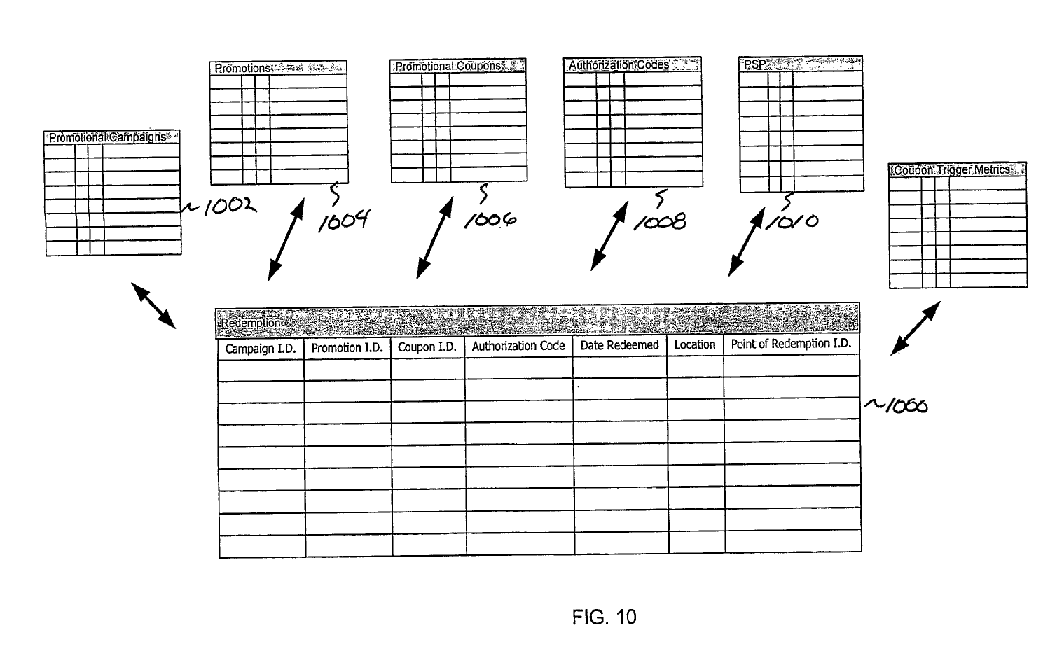

In order to better interpret the tracking of an anonymous player in the PCS as shown in FIG. 9 and the redemption of promotional coupons as shown later in FIG. 10, a cursory explanation of the data of the PCS follows.

A promotional coupon or a plurality of such may be associated with a promotion. A promotion or plurality of such may be associated with a promotional campaign. The types of promotional coupons, promotions, and promotional campaigns may include any of those previously discussed in this document.

Key data for a promotional campaign may include a unique identifier for the promotional campaign as well as the type of promotional campaign, any promotions associated with the promotional campaign, and any related triggers or parameters such as a date and time the promotional campaign begins and a date and time the promotional campaign ends.

Key data for a promotion may include a unique identifier for the promotion as well as the type of promotion, any promotional coupons associated with the promotion, and any related triggers or parameters such as a date and time the promotion begins and a date and time the promotion ends.

Key data for a promotional coupon may include a unique identifier for the promotional coupon as well as the type of promotional coupon, print regions, template used for the creation of the promotional coupon, and any related triggers or parameters such as a date, a time, and duration of play.

Additionally, data for a promotional campaign, promotion, or promotional coupon may be static or variable. The static data may contain various fixed portions of the printed indicia of promotional coupons that a GVP may use in the future creation of a promotional coupon. The static data may include one or a plurality of Coupon Trigger Metrics, one or a plurality of Coupon Issuance Control Parameters, a unique promotional campaign identifier, an authorization code, among others, the static data stored in the memory connected to a GVP. The variable data may contain portions of printed indicia of promotional coupons or a unique promotional campaign identifier, an authorization code, among others. The variable data is matched by a GVP to any variable data stored in the memory of a GVP. The GVP combines portions of static and variable data to print a promotional coupon.

The basis for the creation of all promotional coupons is a promotional coupon template which allows print regions such as a barcode region to be defined. Print regions may include text, barcode, line, box, a graphic, a plurality of any, or a combination of any. Any print region may contain static or variable data.

Turning to FIG. 9, a database entry may exist for each anonymous player a casino desires to track. An anonymous player tracking database 900 includes data derived from promotional coupons 902, authorization codes 904, a PSP 906 or plurality of such, and the Coupon Trigger Metrics 908 to form a record in the anonymous player tracking database. Additional data may also be included.

The contents of each record as shown in FIG. 9 are defined in Table I as follows:

TABLE I

| Column | Description/Association |
|---|---|
| Authorization Code | A validated authorization code. From the Authorization Code |
| | database. |
| Coupon I.D. | A unique identifier of a promotional coupon. From the |
| | Promotional Coupons database. |
| Date Issued | The date the promotional coupon was issued. From the Coupon |
| | Trigger Metrics or Promotional Coupon database. |
| Date Redeemed | The date the promotional coupon was redeemed. From the |
| | Coupon Trigger Metrics, Promotional Coupon database, or the |
| | PSP. |
| Location | The location where the promotional coupon was redeemed. From |
| | the PSP or other. |
| Point of Redemption I.D. | A unique identifier for the Point of Redemption in which a |
| | promotional coupon was redeemed. From the PSP or other. |
| Cash-out Amount | The amount given at the time a player cashed out of a gaming |
| | machine. From the PSP. |

FIG. 10 is a tabular view of the databases and associations thereof for the redemption of promotional coupons in accordance with an exemplary embodiment of the present invention.

As shown, a Redemption database 1000 includes data derived from promotional campaigns 1002, promotions 1004, promotional coupons 1006, authorization codes 1008, a PSP 1010 or plurality of such, and the Coupon Trigger Metrics 1012 to form a record in the Redemption database 1000. Additional data may also be included.

The contents of each record as shown in FIG. 10 are defined in Table II as follows:

TABLE II

| Column | Description/Association |
|---|---|
| Campaign I.D. | A unique identifier of a promotional campaign. From the |
| | Promotional Campaigns database. |
| Promotion I.D. | A unique identifier of a promotion. From the Promotions |
| | database. |
| Coupon I.D. | A unique identifier of a promotional coupon. From the |
| | Promotional Coupons database. |
| Authorization Code | A validated authorization code. From the Authorization Code |
| | database. |
| Date Redeemed | The date the promotional coupon was redeemed. From the |
| | Coupon Trigger Metrics, Promotional Coupon database, or the |
| | PSP. |
| Location | The location where the promotional coupon was redeemed. From |
| | the PSP or other. |
| Point of Redemption I.D. | A unique identifier for the Point of Redemption in which a |
| | promotional coupon was redeemed. From the PSP or other. |

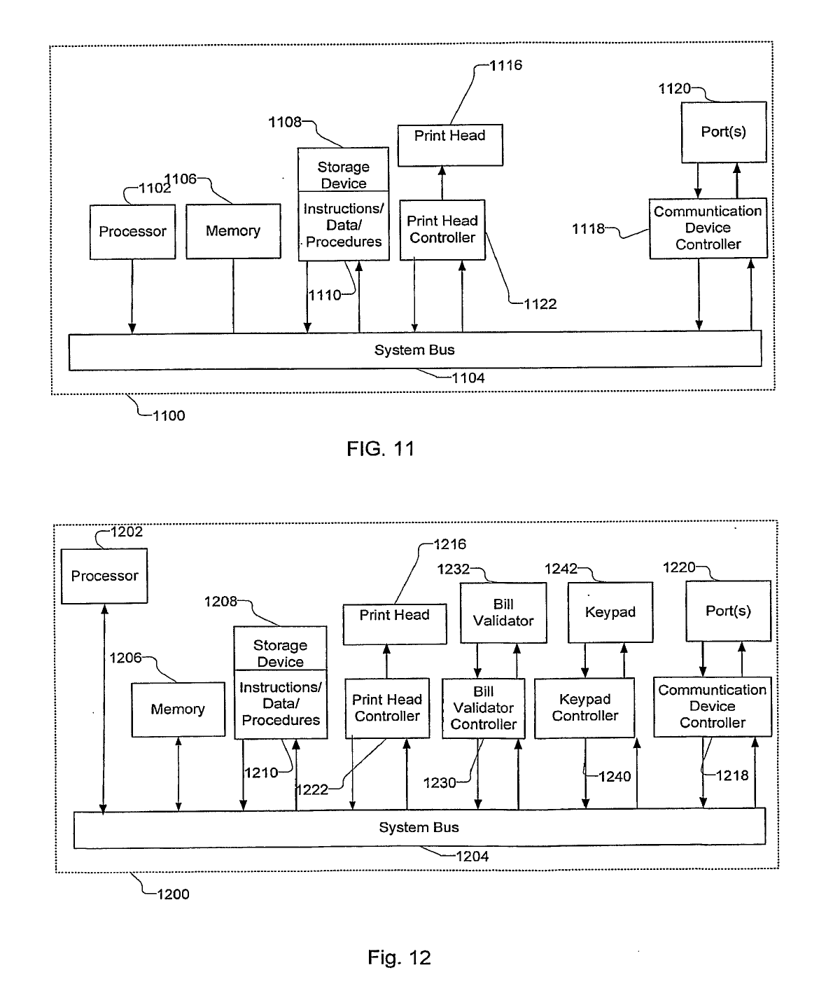

FIG. 11 is a diagram of a GVP and components thereof in accordance with an exemplary embodiment of the present invention. A component or plurality of components shown in FIG. 11 are optional.

A GVP 1100 includes a processor 1102, operatively coupled via a system bus 1104 to a memory 1106. The processor is further operatively coupled via the system bus to a storage device 1108. Program instructions and data 1110 implementing the procedures as described herein for a GVP are stored in the storage device until the processor retrieves the program instructions and stores them in the memory. The processor then executes the program instructions stored in the memory to implement any of the features of the GVP as described herein.

The processor is further coupled via the system bus to a communication device controller 1118 that is coupled to one or more communication ports 1120. The GVP uses the communication device controller and communication ports to transmit and receive control signals from external hosts and devices as described herein.

The processor is further coupled via the system bus to a printer head controller 1122 that is coupled to a printer head 1116. The GVP uses the printer head to print vouchers and coupons as described herein.

Although the GVP has been described in terms of a computing system having a processor, computer-readable media, such as a memory, and instructions, such as a computer-executable program, executed by the processor, it is to be understood that the foregoing has been presented by way of example and not of limitation. It is to be understood that a GVP may also be implemented using software or the like, hardwired circuitry or the like, programmable components or the like, or any combination thereof.

FIG. 12 is a diagram of a Point of Redemption and components thereof in accordance with an exemplary embodiment of the present invention. A component or plurality of components shown in FIG. 12 are optional.

A Point of Redemption 1200 includes a processor 1202, operatively coupled via a system bus 1204 to a memory 1206. The processor is further operatively coupled via the system bus to a storage device 1208. Program instructions and data 1210 implementing the procedures as described herein for a Point of Redemption are stored in the storage device until the processor retrieves the program instructions and stores them in the memory. The processor then executes the program instructions stored in the memory to implement any of the features of the Point of Redemption as described herein.

The processor is further coupled via the system bus to a communication device controller 1218 that is coupled to one or more communication ports 1220. The Point of Redemption uses the communication device controller and communication ports to transmit and receive control signals from external hosts and devices as described herein.

The processor is further coupled via the system bus to a printer head controller 1222 that is coupled to a printer head 1216. The Point of Redemption uses the printer head to print vouchers and coupons as described herein.

The processor is further coupled via the system bus to a bill validator controller 1230 that is coupled to a bill validator 1232. The Point of Redemption uses the bill validator to read coupons and vouchers as described herein.

The processor is further coupled via the system bus to a keypad controller 1240 that is coupled to a keypad 1242. The Point of Redemption uses the keypad to receive authorization codes from a player as described herein.

Although the Point of Redemption has been described in terms of a computing system having a processor, computer-readable media, such as a memory, and instructions, such as a computer-executable program, executed by the processor, it is to be understood that the foregoing has been presented by way of example and not of limitation. It is to be understood that a Point of Redemption may also be implemented using software or the like, hardwired circuitry or the like, programmable components or the like, or any combination thereof.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of tracking an anonymous player, comprising:
issuing by a central processing unit a promotional coupon to the anonymous player, the promotional coupon including a unique identifier;
issuing by the central processing unit an authorization code unique to each promotional coupon issued by the central processing unit regardless of the number of times the same promotional coupon was issued to various players;
associating by the central processing unit the promotional coupon's unique identifier with the authorization code;
redeeming the promotional coupon at a point of redemption by the central processing unit using the promotional coupon's unique identifier and the authorization code.

2. The method of claim 1, further comprising:
requesting by the point of redemption validation of the promotional coupon by the central processing unit; and
signaling by the central processing unit the validity of a promotional coupon,
wherein the point of redemption redeems the promotional coupon if valid, and
wherein, the point of redemption returns the coupon to the anonymous player if invalid.

3. The method of claim 2, further comprising:
signaling by the point of redemption, redemption of the promotional coupon to the central processing unit; and
updating by the central processing unit data related to the promotional coupon.

4. The method of claim 1, further comprising:
requesting by the central processing unit from a player tracking system the authorization code; and
issuing by the player tracking system the authorization code without further processing the anonymous player's personal data.

5. The method of claim 1, further comprising offering an incentive by the point of redemption to the anonymous player join a player tracking system.

6. The method of claim 1, further comprising:
issuing by the central processing unit a series of promotional coupons to the anonymous player based on the activities of the anonymous player captured through the central processing unit's association of the promotional coupon's unique identifier and the authorization code.

7. The method of claim 6, wherein issuing the series of promotional coupons is triggered by redeeming the promotional coupon.

8. The method of claim 1, further comprising receiving by the central processing unit signaling from a gaming voucher printer indicating a cash-out signal by the anonymous player, data from the signaling becoming a trigger for issuing the promotional coupon.

9. The method of claim 1, further comprising receiving by the central processing unit signaling from a gaming voucher printer indicating a cash-in signal by the anonymous player, data from the signaling becoming a trigger for issuing the promotional coupon.

10. The method of claim 1, further comprising receiving by the point of redemption the authorization code from the anonymous player using a keypad.

11. The method of claim 1, further comprising scanning a barcode on the promotional coupon by the point of redemption to redeem the promotional coupon.

12. The method of claim 11, wherein the authorization code is in a human-readable format.

13. The method of claim 11, wherein the authorization code is in a machine-readable format.

14. The method of claim 1, wherein the authorization code is a player identification number from a player tracking system.

15. An apparatus for tracking an anonymous player, comprising:
means for issuing by a central processing unit a promotional coupon to the anonymous player, the promotional coupon including a unique identifier;
means for issuing by the central processing unit an authorization code unique to each promotional coupon issued by the central processing unit regardless of the number of times the same promotional coupon was issued to various players;
means for associating by the central processing unit the promotional coupon's unique identifier with the authorization code;
means for redeeming the promotional coupon at a point of redemption by the central processing unit using the promotional coupon's unique identifier and the authorization code.

16. The apparatus of claim 15, further comprising:
means for requesting by the point of redemption validation of the promotional coupon by the central processing unit; and
means for signaling by the central processing unit the validity of a promotional coupon,
wherein the point of redemption redeems the promotional coupon if valid, and
wherein the point of redemption returns the coupon to the anonymous player if invalid.

17. The apparatus of claim 16, further comprising:
means for signaling by the point of redemption, redemption of the promotional coupon to the central processing unit;
means for updating by the central processing unit data related to the promotional coupon; and

18. The apparatus of claim 15 further comprising:
means for requesting by the central processing unit from a player tracking system the authorization code; and
means for issuing by the player tracking system the authorization code without further processing the anonymous player's personal data.

19. The apparatus of claim 15, further comprising means for offering an incentive by the point of redemption to the anonymous player join a player tracking system.

20. The apparatus of claim 15, further comprising:
means for issuing by the central processing unit a series of promotional coupons to the anonymous player based on the activities of the anonymous player captured through the central processing unit's association of the promotional coupon's unique identifier and the authorization code.

21. The apparatus of claim 20, wherein issuing the series of promotional coupons is triggered by redeeming the promotional coupon.

22. The apparatus of claim 15, further comprising means for receiving by the central processing unit signaling from a gaming voucher printer indicating a cash-out signal by the anonymous player, data from the signaling becoming a trigger for issuing the promotional coupon.

23. The apparatus of claim 15, further comprising means for receiving by the central processing unit signaling from a gaming voucher printer indicating a cash-in signal by the anonymous player, data from the signaling becoming a trigger for issuing the promotional coupon.

24. The apparatus of claim 15, further comprising means for receiving by the point of redemption the authorization code from the anonymous player using a keypad.

25. The apparatus of claim 15, further comprising means for scanning a barcode on the promotional coupon by the point of redemption to redeem the promotional coupon.

26. The apparatus of claim 25, wherein the authorization code is in a human-readable format.

27. The apparatus of claim 25, wherein the authorization code is in a machine-readable format.

28. The apparatus of claim 15, wherein the authorization code is a player identification number from a player tracking system.

29. A computer-readable medium storing a computer-executable program for tracking an anonymous player, the computer-executable program comprising:
issuing by a central processing unit a promotional coupon to the anonymous player, the promotional coupon including a unique identifier;
issuing by the central processing unit an authorization code unique to each promotional coupon issued by the central processing unit regardless of the number of times the same promotional coupon was issued to various players;
associating by the central processing unit the promotional coupon's unique identifier with the authorization code;
redeeming the promotional coupon at a point of redemption by the central processing unit using the promotional coupon's unique identifier and the authorization code.

30. The computer-readable medium of claim 29, the computer-executable program further comprising:
requesting by the point of redemption validation of the promotional coupon by the central processing unit; and
signaling by the central processing unit the validity of a promotional coupon,
wherein the point of redemption redeems the promotional coupon if valid, and
wherein, the point of redemption returns the coupon to the anonymous player if invalid.

31. The computer-readable medium of claim 30, the computer-executable program further comprising:
signaling by the point of redemption, redemption of the promotional coupon to the central processing unit; and
updating by the central processing unit data related to the promotional coupon.

32. The computer-readable medium of claim 29, the computer-executable program further comprising:
requesting by the central processing unit from a player tracking system the authorization code; and
issuing by the player tracking system the authorization code without further processing the anonymous player's personal data.

33. The computer-readable medium of claim 29, the computer-executable program further comprising offering an incentive by the point of redemption to the anonymous player join a player tracking system.

34. The computer-readable medium of claim 29, the computer-executable program further comprising:
issuing by the central processing unit a series of promotional coupons to the anonymous player based on the activities of the anonymous player captured through the central processing unit's association of the promotional coupon's unique identifier and the authorization code.

35. The computer-readable medium of claim 34, wherein issuing the series of promotional coupons is triggered by redeeming the promotional coupon.

36. The computer-readable medium of claim 29, the computer-executable program further comprising receiving by the central processing unit signaling from a gaming voucher printer indicating a cash-out signal by the anonymous player, data from the signaling becoming a trigger for issuing the promotional coupon.

37. The computer-readable medium of claim 29, the computer-executable program further comprising receiving by the central processing unit signaling from a gaming voucher printer indicating a cash-in signal by the anonymous player, data from the signaling becoming a trigger for issuing the promotional coupon.

38. The computer-readable medium of claim 29, the computer-executable program further comprising receiving by the point of redemption the authorization code from the anonymous player using a keypad.

39. The computer-readable medium of claim 29, the computer-executable program further comprising scanning a barcode on the promotional coupon by the point of redemption to redeem the promotional coupon.

40. The computer-readable medium of claim 39, wherein the authorization code is in a human-readable format.

41. The computer-readable medium of claim 39, wherein the authorization code is in a machine-readable format.

42. The computer-readable medium of claim 29, wherein the authorization code is a player identification number from a player tracking system.
